(19) United States
(12) Patent Application Publication
(10) Pub. No.: US 2022/0193956 A1
(43) Pub. Date: Jun. 23, 2022

(54) Die Assembly for Producing Fluid-Filled Pellets

(71) Applicants: Dow Global Technologies LLC, Midland, MI (US); DOW SILICONES CORPORATION, Midland, MI (US)

(72) Inventors: Wenyi Huang, Midland, MI (US); Nicholas J. Horstman, Midland, MI (US); Jeffrey D. Wenzel, Midland, MI (US); Qian Gou, Collegeville, PA (US); Yabin Sun, Shanghai (CN); Mohamed Esseghir, Collegeville, PA (US); Yunfeng Yang, Shanghai (CN); Yonghua Gong, Shanghai (CN); Weiming Ma, Shanghai (CN); Hong Yang, Shanghai (CN)

(21) Appl. No.: 17/599,368

(22) PCT Filed: Mar. 29, 2019
(86) PCT No.: PCT/CN2019/080380

§ 371 Date: Sep. 28, 2021

(51) Int. Cl. B29B 9/06; B29B 9/12

(52) U.S. Cl. CPC B29B 9/065; B29K 2101/12; B29B 9/12

(57) ABSTRACT

A die assembly (5) including: (i) a die plate (10) having an inlet surface (15) and an opposing discharge surface (35); (ii) an inlet (30) on the inlet surface (15) and a first axis of symmetry (A) extending through the inlet (30) and perpendicular to the inlet surface (15); (iii) a discharge port (45) on the discharge surface (35) and a second axis of symmetry (B) extending through the discharge port (45) and perpendicular to the discharge surface (35). The first and second axes are apart from, and parallel to, one another. The die assembly (5) includes (iv) an extrudate passage (42) fluidly connecting the inlet (30) and the discharge port (45). A third axis of symmetry (C) extends through the extrudate passage (42). The die assembly (5) includes (v) a nozzle (100) mounted in the die plate (10), the nozzle (100) having an injection tip (110) in the extrudate passage (42) at the discharge port (45); and (vi) the third axis of symmetry (C) intersects the first axis of symmetry (A) to form an acute angle.

### BACKGROUND

It is known to soak pellets of polymer resin in liquid additives in order to infuse, or otherwise combine, the additive to the polymeric pellets prior to further processing. In the production plastic coatings for power cables for example, olefin-based polymer pellets are oftentimes soaked in liquid peroxide prior to melt-blending or melt extrusion with other ingredients.

Unfortunately, additive soaking of olefin-based polymer pellets suffers from several drawbacks. Many olefin-based polymer pellets require long soaking times—10 or more hours—in order to incorporate sufficient amount of additive into the pellet. Such long soaking times impart added capital costs for soaking equipment and decrease production throughput rates.

The use of porous pellets is known as a way to reduce the soak time for olefin-based polymer pellets. However, porous olefin-based polymer pellets are expensive to produce, limiting their practical use in industry. Porous olefin-based polymer pellets also exhibit inhomogeneity issues when melt blended or extruded. Consequently, the art recognizes the need for polymeric resin pellets with increased surface area in order to decrease additive soak time without deleteriously impacting downstream production steps.

The art further recognizes the need for equipment that can produce polymeric resin pellets with increased surface area for industrial applications that require an additive soak step for polymeric resin pellets—such as the coating of power cables, for example.

### SUMMARY

The present disclosure provides a die assembly. In an embodiment, the die assembly includes: (i) a die plate having an inlet surface and an opposing discharge surface; (ii) an inlet on the inlet surface and a first axis of symmetry extending through the inlet and perpendicular to the inlet surface; (iii) a discharge port on the discharge surface and a second axis of symmetry extending through the discharge port and perpendicular to the discharge surface. The second axis of symmetry is spaced apart from, and is parallel to, the first axis of symmetry. The die assembly includes (iv) an extrudate passage fluidly connecting the inlet and the discharge port. A third axis of symmetry extends through the extrudate passage. The die assembly includes (v) a nozzle mounted in the die plate, the nozzle having an injection tip in the extrudate passage at the discharge port; and (vi) the third axis of symmetry intersects the first axis of symmetry at the inlet to form an acute angle.

### BRIEF DESCRIPTION OF THE DRAWINGS

FIG. 1A is a perspective view of an upstream face of a die plate in accordance with an embodiment of the present disclosure.

FIG. 1B is a perspective view of a downstream face of the die plate in accordance with an embodiment of the present disclosure.

FIG. 2 is an exploded view of a die assembly in accordance with an embodiment of the present disclosure.

FIG. 3 is a cross-sectional view of the die assembly taken along line 3-3 of FIG. 2.

FIG. 4A is an enlarged view of Area 4A of FIG. 3.

FIG. 4B is an enlarged view of Area 4B of FIG. 4A.

FIG. 4C is an enlarged, cross-sectional view of a die assembly including an exit plate in accordance with an embodiment of the present disclosure.

FIG. 5 is the sectional view of FIG. 4A showing extrudate flow through the die assembly and production of fluid-filled pellets in accordance with an embodiment of the present disclosure.

FIG. 6 is a perspective view of a hollow pellet, in accordance with an embodiment of the present disclosure.

FIG. 7A is a cross-sectional view of the pellet as viewed along line 7A-7A of FIG. 6.

FIG. 7B is a cross-sectional view of the pellet as viewed along line 7B-7B of FIG. 6.

FIG. 8 is an exploded view of the pellet of FIG. 6.

FIG. 9 is a perspective view of a closed pellet, in accordance with an embodiment of the present disclosure.

FIG. 10A is a cross-sectional view of the closed pellet as viewed along line 10A-10A of FIG. 9.

### DEFINITIONS

For purposes of United States patent practice, the contents of any referenced patent, patent application or publication are incorporated by reference in their entirety (or its equivalent U.S. version is so incorporated by reference), especially with respect to the disclosure of definitions (to the extent not inconsistent with any definitions specifically provided in this disclosure) and general knowledge in the art.

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, (whether polymerized or otherwise), unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

Unless stated to the contrary, implicit from the context, or customary in the art, all parts and percentages are based on weight and all test methods are current as of the filing date of this disclosure.

“Blend,” “polymer blend” and like terms refer to a combination of two or more polymers. Such a blend may or may not be miscible. Such a combination may or may not be phase separated. Such a combination may or may not contain one or more domain configurations, as determined from transmission electron spectroscopy, light scattering, x-ray scattering, and any other method known in the art.

“Ethylene-based polymer” is a polymer that contains more than 50 weight percent polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra-low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, medium density polyethylene (MDPE), and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations. In an embodiment, the ethylene-based polymer does not contain an aromatic comonomer polymerized therein.

“Ethylene plastomers/elastomers” are substantially linear, or linear, ethylene/α-olefin copolymers containing homogeneous short-chain branching distribution comprising units derived from ethylene and units derived from at least one C₃-C₁₀α-olefin comonomer, or at least one C₄-C₈ α-olefin comonomer, or at least one C₆-C₈ α-olefin comonomer. Ethylene plastomers/elastomers have a density from 0.870 g/cc, or 0.880 g/cc, or 0.890 g/cc to 0.900 g/cc, or 0.902 g/cc, or 0.904 g/cc, or 0.909 g/cc, or 0.910 g/cc, or 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins, ELITE™ Enhanced Polyethylene Resins, and CONTINUUM™ Bimodal Polyethylene Resins, each available from The Dow Chemical Company; LUPOLEN™, available from LyondellBasell; and HDPE products from Borealis, Ineos, and ExxonMobil.

An “interpolymer” (or “copolymer”), is a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

“Low density polyethylene” (or “LDPE”) consists of ethylene homopolymer, or ethylene/α-olefin copolymer comprising at least one C₃-C₁₀ α-olefin, preferably C₃-C₄ that has a density from 0.915 g/cc to 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins and DOWLEX™ polyethylene resins, each available from the Dow Chemical Company; and MARLEX™ polyethylene (available from Chevron Phillips).

“Multi-component ethylene-based copolymer” (or “EPE”) comprises units derived from ethylene and units derived from at least one C₃-C₁₀ α-olefin comonomer, or at least one C₄-C₈ α-olefin comonomer, or at least one C₆-C₈ α-olefin comonomer, such as described in patent references U.S. Pat. Nos. 6,111,023; 5,677,383; and 6,984,695. EPE resins have a density from 0.905 g/cc, or 0.908 g/cc, or 0.912 g/cc, or 0.920 g/cc to 0.926 g/cc, or 0.929 g/cc, or 0.940 g/cc, or 0.962 g/cc. Nonlimiting examples of EPE resins include ELITE™ enhanced polyethylene and ELITE AT™ advanced technology resins, each available from The Dow Chemical Company; SURPASS™ Polyethylene (PE) Resins, available from Nova Chemicals; and SMART™, available from SK Chemicals Co.

An “olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer and propylene-based polymer. An “olefin” and like terms refers to hydrocarbons consisting of hydrogen and carbon whose molecules contain a pair of carbon atoms linked together by a double bond.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

“Single-site catalyzed linear low density polyethylenes” (or “m-LLDPE”) are linear ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. m-LLDPE has density from 0.913 g/cc, or 0.918 g/cc, or 0.920 g/cc to 0.925 g/cc, or 0.940 g/cc. Nonlimiting examples of m-LLDPE include EXCEED™ metallocene PE (available from ExxonMobil Chemical), LUFLEXEN™ m-LLDPE (available from LyondellBasell), and ELTEX™ PF m-LLDPE (available from Ineos Olefins & Polymers).

“Ultra low density polyethylene” (or “ULDPE”) and “very low density polyethylene” (or “VLDPE”) each is a linear ethylene/α-olefin copolymer containing heterogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. ULDPE and VLDPE each has a density from 0.885 g/cc, or 0.90 g/cc to 0.915 g/cc. Nonlimiting examples of ULDPE and VLDPE include ATTANE™ ULDPE resins and FLEXOMER™ VLDPE resins, each available from The Dow Chemical Company.

“Melt blending” is a process in which at least two components are combined or otherwise mixed together, and at least one of the components is in a melted state. The melt blending may be accomplished by one or more of various know processes, e.g., batch mixing, extrusion blending, extrusion molding, and the like. “Melt blended” compositions are compositions which were formed through the process of melt blending.

“Thermoplastic polymer” and like terms refers to a linear or branched polymer that can be repeatedly softened and made flowable when heated and returned to a hard state when cooled to room temperature. A thermoplastic polymer typically has an elastic modulus greater than 68.95 MPa (10,000 psi) as measured in accordance with ASTM D638-72. In addition, a thermoplastic polymer can be molded or extruded into an article of any predetermined shape when heated to the softened state.

“Thermoset polymer”, “thermosetting polymers” and like terms indicate that once cured, the polymer cannot be softened nor further shaped by heat. Thermosetting polymers, once cured, are space network polymers and are highly crosslinked to form rigid three-dimensional molecular structures.

### DETAILED DESCRIPTION

The present disclosure provides a die assembly. The die assembly includes a die plate having an inlet surface and a discharge surface. The discharge surface and the inlet surface are on opposite side of the die plate. The inlet surface includes an inlet. A first axis of symmetry, which is perpendicular to the inlet surface, extends through the inlet. The discharge surface includes a discharge port. A second axis of symmetry, which is perpendicular to the discharge surface, extends through the discharge port. The first and second axes of symmetry are spaced apart from one another and are parallel to one another. The die plate includes an extrudate passage that extends from the inlet to the discharge port, (i.e., the extrudate passage fluidly connects the inlet and the discharge port). The die plate includes a third axis of symmetry that extends through the extrudate passage. The die assembly includes a nozzle that is mounted in the die plate. The nozzle has an injection tip. The injection tip of the nozzle is located in the extrudate passage at the discharge port. The third axis of symmetry intersects the first axis of symmetry at the inlet to form an acute angle.

### Die Plate

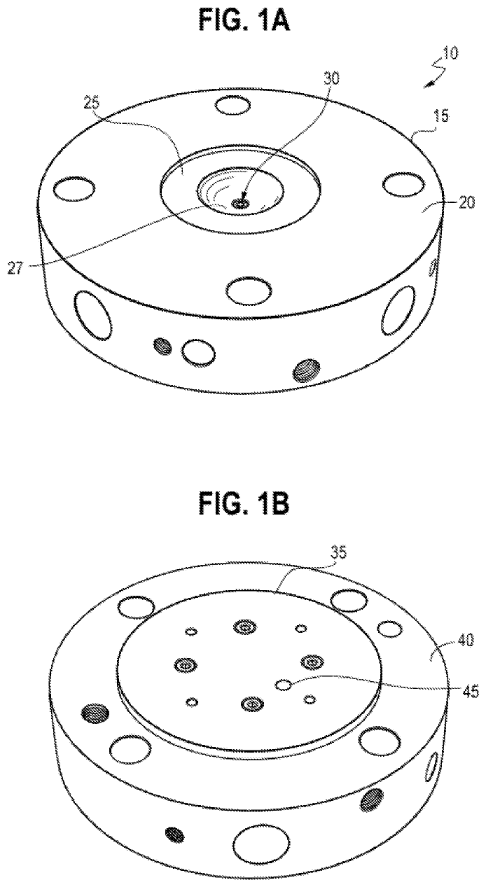

Referring to the drawings and initially to FIG. 1A, die assembly 5 includes a die plate 10. FIG. 1A shows die plate 10 having an inlet surface 15 and an inlet 30 that is circular in shape. The inlet 30 is located at the center of, and opens into, the die plate 10. An intake plate 25 has an upstream face that is circular in shape. The inlet 30 and the intake plate 25 form concentric circles. The intake plate 25 includes an intake port 27, the intake port 27 having a shape that is conical. The intake port 27 has a downstream end that is circular in shape and that is aligned with the inlet 30. The die assembly 5 may be used, for example, with an extruder (not shown) to form fluid-filled pellets, such as those described herein. The intake port 27 and the inlet 30 are adapted to receive an extrudate (not shown) from the extruder. The term “adapted to receive,” as used herein, indicates that the shape and dimensions of the intake port 27 and the inlet 30 allow the extrudate to flow from the extruder through the inlet 30 and into the die assembly 5 with no leakage of the extrudate. The extruder is operatively connected to the die assembly 5 at an upstream face 20 of die plate 10, as indicated in FIG. 1A.

The terms “upstream” and “downstream” refer to the spatial location of two objects (or components) with respect to each other, whereby “upstream” indicates a position closer to the extrudate source (e.g., the extruder) compared to the term “downstream” referring to a position further away from the extrudate source. Stated differently, with respect to two objects, the first object “upstream” of the second object indicates that the first object is closer to the extrudate source than is the second object, the second object being “downstream” of the first object.

In an embodiment, the die plate 10 is made of one or more metals. Nonlimiting examples of suitable metals include steel, stainless steel, metal composites, and combinations thereof.

In an embodiment, the die plate 10 is made of P-20 steel. In another embodiment, the die plate 10 is made of one or more metal composites.

FIG. 1B shows the discharge surface 35 and the discharge port 45 of the die plate 10. The discharge surface 35 is located on a downstream face 40 of the die plate 10 as indicated in FIG. 1B.

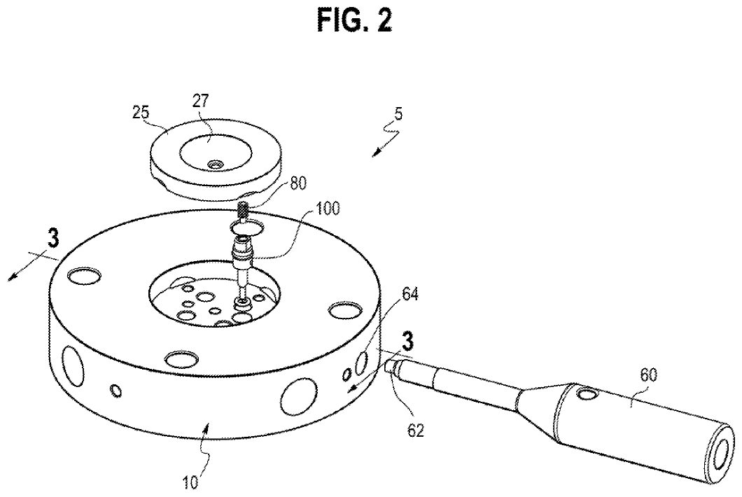

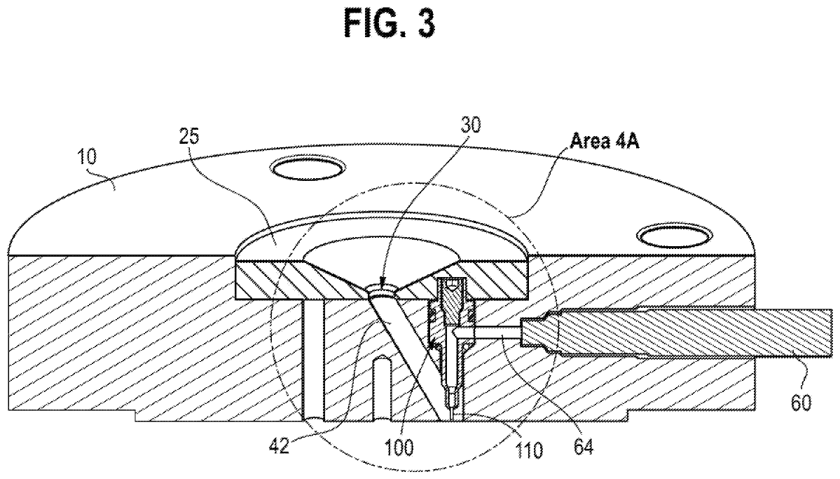

FIG. 2 shows a fluid source 60, an adapter screw 80 and a nozzle 100. The fluid source 60 houses a fluid 50 and includes an insert end 62. It is understood that fluid 50 is distinct from, and different than, the extrudate that enters the inlet 30 from the extruder. Adapter screw 80 is attached to a downstream side of intake plate 25. Nozzle 100 is attached to adapter screw 80. Nozzle 100 is mounted in die plate 10 through the combination of the adapter screw 80 and the intake plate 25.

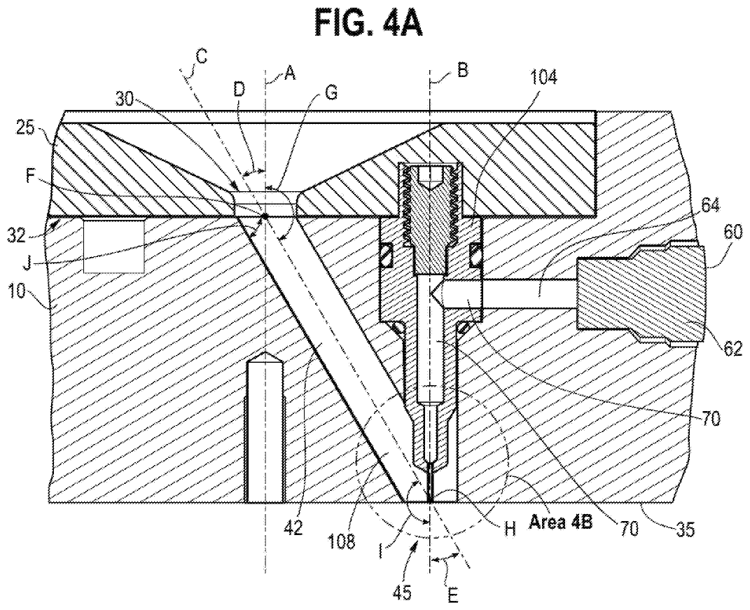

FIG. 4A shows the die assembly 5 with the nozzle 100 mounted in the die plate 10. A first axis of symmetry A is shown. The first axis of symmetry A extends through the inlet 30 and is perpendicular to a plate surface 32. The plate surface 32 occupies a plane (not shown) defined by an interface between the intake plate 25 and the die plate 10. In an embodiment, the first axis of symmetry A bisects the inlet 30.

FIG. 4A shows a second axis of symmetry B, the second axis of symmetry B extending through the discharge port 45. The second axis of symmetry B is perpendicular to the discharge surface 35. The second axis of symmetry B is spaced apart from, and is parallel to, the first axis of symmetry A, as shown in FIG. 4A.

FIG. 4A shows an extrudate passage 42, the extrudate passage 42 fluidly connecting the inlet 30 and the discharge port 45. A downstream end of the extrudate passage 42 surrounds a downstream section of nozzle 100. A third axis of symmetry C extends through the inlet 30, the extrudate passage 42 and the discharge port 45. An upstream portion of the third axis of symmetry C is disposed parallel to an upstream portion of the extrudate passage 42. The third axis of symmetry C intersects the first axis of symmetry A to form a vertex point F and an acute angle D at the inlet 30. The acute angle D is distinguished from the obtuse angle G where the value of the acute angle D is less than 90°, the value of the obtuse angle G is greater than 90, and the sum of the value of the acute angle D and the value of the obtuse angle G is exactly 180°. The third axis of symmetry C also intersects the second axis of symmetry B to form to form a vertex point H and an acute angle E at the discharge port 45. The acute angle E is distinguished from the obtuse angle I where the value of the acute angle E is less than 90°, the value of the obtuse angle I is greater than 90, and the sum of the value of the acute angle E and the value of the obtuse angle I is exactly 180°.

In an embodiment, the value of the acute angle D is the same as the value of the acute angle E.

FIG. 4A shows an extrudate angle J. The extrudate angle J is the angle between the slope of extrudate channel 42 and a horizontal line defined by the plate surface 32 (i.e., the interface of the intake plate 25 and the die plate 10, as described herein). The value of acute angle D is 90 degrees less the value of extrudate angle J. Stated differently, the value of acute angle D is the value of extrudate angle J subtracted from 90 degrees. The value of acute angle E is 90 degrees less the value of extrudate angle J. Stated differently, the value of acute angle E is the value of extrudate angle J subtracted from 90 degrees.

FIG. 4A shows a nozzle proximate end 104 located at the upstream end of the nozzle 100. The nozzle proximate end 104 is in fluid communication with fluid source 60. A nozzle distal end 108 is located at the downstream end of the nozzle 100. The nozzle proximate end 104 and the nozzle distal end 108 are on opposite ends of the nozzle 100. The nozzle distal end 108 includes an injection tip 110, the injection tip 110 having an opening in its center. The injection tip 110 is located in the extrudate passage 42 at the discharge port 45. The nozzle 100 includes an annular channel 70. The annular channel 70 extends from the nozzle proximate end 104 through the body of the nozzle 100 to the opening of the injection tip 110. The annular channel 70 is fluidly connected to the fluid source 60 through the fluid channel 64.

In an embodiment, nozzle 100 is a step nozzle. The term “step nozzle,” as used herein, refers to a nozzle having two or more distinct inner diameters. In an embodiment, nozzle 100 is a step nozzle having three distinct inner diameters. In a further embodiment, FIG. 4B shows a proximate inner diameter K, a middle inner diameter L, and a tip inner diameter M wherein the proximate inner diameter K is greater than the middle inner diameter L, and the middle inner diameter L is greater than the tip inner diameter M.

The nozzle proximate end 104 includes a proximate inner diameter K, (or interchangeably referred to as the “PID”) as shown in FIG. 4B. The injection tip 110 includes a tip inner diameter M, (or interchangeably referred to as the “TID”). The PID is greater than the tip inner diameter H.

In an embodiment, the PID is from 2.2 millimeters (mm), or 2.4 mm, or 2.6 mm, or 2.8 mm, or 3.0 mm to 3.4 mm, or 3.6 mm, or 3.8 mm, or 4.1 mm. In a further embodiment, the PID is from 2.2 to 4.1 mm, or from 2.6 to 3.6 mm, or from 3.0 to 3.4 mm.

In an embodiment, the TID is from 0.22 mm, or 0.25 mm, or 0.28 mm, or 0.30 mm to 0.40 mm, or 0.42 mm, or 0.45 mm, or 0.48 mm. In a further embodiment, the TID is from 0.22 to 0.48 mm, or from 0.24 to 0.40 mm, or from 0.25 to 0.35 mm.

A middle inner diameter L is located at a center portion of the nozzle. In an embodiment, the middle inner diameter L is from 1.0 mm, or 1.2 mm, or 1.4 mm, or 1.6 mm to 1.8 mm, or 2.0 mm, or 2.2 mm, or 2.4 mm. In a further embodiment, the middle inner diameter L is from 1.0 to 2.4 mm, or from 1.2 to 2.2 mm, or from 1.6 to 1.8 mm.

A tip outer diameter N is located at the injection tip 110. In an embodiment, the tip outer diameter N is from 0.45 mm, or 0.50 mm, or 0.55 mm, or 0.60 mm to 0.90 mm, or 0.95 mm, or 1.0 mm, or 1.1 mm. In a further embodiment, the tip outer diameter N is from 0.45 to 1.1 mm, or from 0.50 to 1.0 mm, or from 0.60 to 0.90 mm.

FIGS. 4A-4B show the injection tip 110 is located at the terminus of the nozzle distal end 108. The injection tip 110 is located in the extrudate passage 42 at the discharge port 45. In other words, injection tip 110 is wholly surrounded by the extrudate passage 42. As best shown in FIG. 4B, at the discharge port 45, the injection tip 110 is located at a setback position O that is upstream of the discharge face 35 such that the injection tip 110 is not coplanar with the discharge face 35. The extrudate passage 42 wholly surrounds the injection tip 110 at the setback position O.

FIG. 4B shows setback position O for the injection tip 110. In an embodiment, the setback position O is from 0.02 mm, or 0.03 mm, or 0.05 mm to 0.15 mm, or 0.18 mm, or 0.22 mm upstream of the discharge face 35. In a further embodiment, the setback position O is from 0.02 mm to 0.22 mm, or from 0.03 mm to 0.18 mm, or from 0.05 mm to 0.15 mm upstream of the discharge face 35.

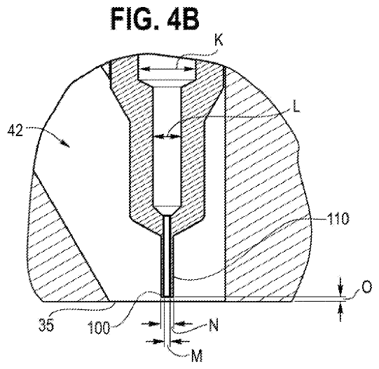

FIG. 5 shows an extrudate 210 in the extrudate passage 42. The extrudate is depicted flowing from the extruder (not shown) and passing through the inlet 30 at arrow 5.1. The extrudate enters the extrudate passage 42 and is uniformly distributed throughout the extrudate passage 42. As indicated by the arrows 5.1 and 5.2 the extrudate flows through the extrudate passage 42 and surrounds the nozzle distal end 108 and the injection tip 110.

FIG. 5 shows a fluid 50. The fluid 50 is depicted passing from the fluid source 60 through the fluid channel 64 at arrow 5.3. The fluid 50 enters the annular channel 70 within the nozzle 100 as indicated by arrow 5.4. The passing of the extrudate 210 and the passing of the fluid 50 occur simultaneously, or substantially simultaneously. Downstream of arrow 5.5 the fluid 50 enters the injection tip and is then injected into the extrudate as the extrudate exits the discharge port 45 to form a fluid-filled extrudate 225.

FIG. 5 shows a rotating blade apparatus 200. The rotating blade apparatus 200 is in operative communication with the discharge port 45 of the discharge surface 35. The rotating blade apparatus 200 repeatedly cuts the fluid-filled extrudate 225 emerging from the discharge port 45, while still in a plastic state, transversely to the direction of flow of the fluid-filled extrudate 225 to form fluid-filled pellets 230 as indicated at arrow 5.6. The spaced distance between cuts and the cutting frequency provide control of the size of the resultant fluid-filled pellets 230. Not wishing to be bound by any particular theory, the viscosity of the extrudate, the setback distance and the cutting frequency are adjusted to produce fluid-filled pellets 230 having two open ends, one open end, or no open ends, the latter case being pellets having two closed ends.

FIG. 4C shows an embodiment of the present disclosure that includes an exit plate 300 attached to the discharge face 45 of the die plate 10. In an embodiment, the exit plate 300 is made of a metal that has a greater hardness value compared to the hardness value for the material of die plate 10. Steel hardness is conveyed with the Rockwell hardness scale (e.g., HRA, HRB, HRC, etc.)

In an embodiment, the exit plate 300 is made of Hardened 01 steel.

The exit plate 300 includes an exit face 310 and an exit port 320 located on the exit face 310. The exit plate 300 includes an exit channel 330, the exit channel 330 fluidly connects the discharge port 45 to the exit port 320. The injection tip 110 extends into the exit channel 330 and the exit channel 330 surrounds the injection tip 110. The injection tip 110 is located at a setback position P that is upstream of the exit face 310 such that the injection tip 110 is not coplanar with the exit face 310. The extrudate passes from extrudate passage 42 into the exit channel 330 and surrounds the injection tip 110 at the setback position P. In an embodiment, the setback position P is from 0.02 mm, or 0.03 mm, or 0.05 mm to 0.15 mm, or 0.18 mm, or 0.22 mm upstream of the exit face 310. In a further embodiment, the setback position P is from 0.02 mm to 0.22 mm, or from 0.03 mm to 0.18 mm, or from 0.05 mm to 0.15 mm upstream of the exit face 310. The injection tip injects the fluid 50 into the extrudate as the extrudate exits the exit port 320 to form a fluid-filled extrudate 225. The rotating blade apparatus 200 cuts the fluid-filled extrudate 225 emerging from the exit port 320 to form fluid-filled pellets 230.

In an embodiment, the rotating blade apparatus 200 is selected from a swinging blade, a reciprocating blade, a rotating knife blade, a rotating circular knife blade, a wet-cut underwater strand pelletizer, and a die-face cutter.

In an embodiment, the downstream face of the die assembly 5 and the rotating blade apparatus 200 are submerged completely in a process fluid. The process fluid is selected from water, an oil, a heat transfer fluid, a lubricant or a combination thereof.

### Fluid

Nozzle 100 injects fluid 50 into the extrudate to form the fluid-filled extrudate 225 as shown in FIG. 5. Non-limiting examples of a fluid suitable for use as the fluid 50 include a gas, a liquid, a flowable thermoplastic polymer or a combination thereof.

In an embodiment, the gas used as fluid 50 is air, an inert gas, (nitrogen or argon, for example), or a combination thereof. In a further embodiment, the gas used as fluid 50 is air. In a further embodiment, the gas used as fluid 50 is nitrogen.

In an embodiment, the fluid 50 is nitrogen gas. The pressure of the nitrogen gas is from 5 psig, or 10 psig, or 20 psig to 30 psig, or 50 psig, or 200 psig. In a further embodiment, the pressure of the nitrogen gas is from 5 to 200 psig, or from 10 to 50 psig, or from 20 to 30 psig.

In an embodiment, the nitrogen gas has a flow rate from 2 milliliters per min (mL/min), or 5 mL/min, or 10 psig, or 20 mL/min, or 30 mL/min to 40 ml/min, or 50 mL/min, or 100 mL/min, or 200 ml/min. In a further embodiment, the nitrogen flow rate is from 2 to 200 ml/min, or from 5 to 100 mL/min, or from 10 to 50 ml/min.

In an embodiment, fluid 50 is a liquid. Non-limiting examples of suitable liquid include a peroxide, a curing coagent, a silane, an antioxidant, a UV stabilizer, a processing aid, a coupling agent and combinations thereof. In an embodiment, the liquid used as fluid 50 is blended in a polymer carrier. In a further embodiment, other components are added to the fluid 50, the other components accelerate solidification of the fluid 50. Non-limiting examples of other components suitable include oligomers, nucleating agents and a combination thereof.

The fluid 50 may comprise two or more embodiments disclosed herein.

### Pellets

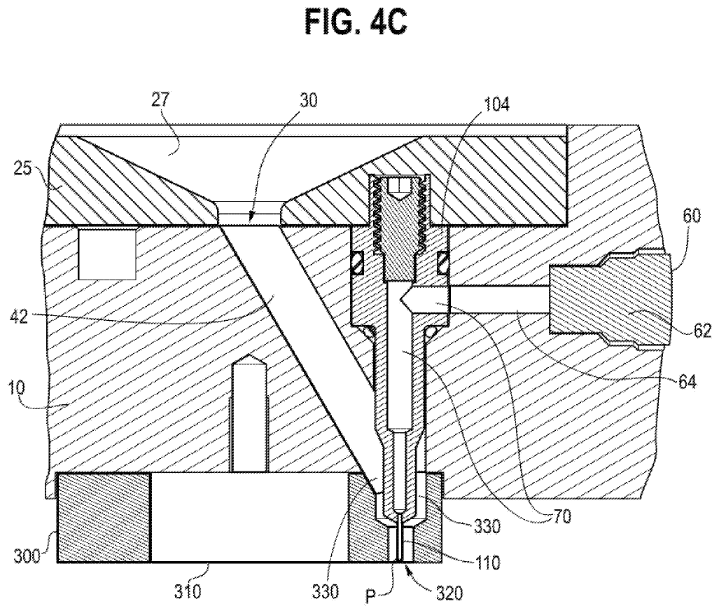

FIG. 6 shows a fluid-filled pellet produced by die assembly 5. Not wishing to be bound by any particular theory, the viscosity of the extrudate determines the disposition of the ends of the fluid-filled pellet. Absent interactions with a second object, higher viscosity extrudates exhibit less flow after the rotating blade apparatus 200 cuts the fluid-filled extrudate 225. The ends of higher viscosity extrudates therefore have a greater tendency to remain open when compared to the ends of lower viscosity extrudates. However, higher viscosity extrudates exhibit a higher tendency to be pulled along with the blade (i.e., shear behavior) when compared to lower viscosity extrudates. The shear behavior imparts to higher viscosity extrudates a higher tendency to be closed by the blade and form a closed end when compared to lower viscosity extrudates. The phenomenon of the extrudate being cut and pulled along with the blade to form a closed end is referred to herein as “round up,” where higher incidence of closed ends is referred to as greater round up.

In an embodiment, the setback distance of the injection tip 110 influences the amount of round up.

In an embodiment, the setback distance and the extrude viscosity are selected so die assembly 5 produces fluid-filled pellet 610 having open ends as shown in FIG. 6. Pellet 610 includes a body 620. The body 620 includes a first open end 615 and a second open end 625. Pellet 610 includes a channel 630. Channel 630 extends through the body 620 from the first open end 615 to the second open end 625. Pellet 610 with body 620 and channel 630 extending therethrough is hereafter interchangeably referred to as a “hollow pellet.”

In an embodiment, the body 620 has a cylindrical shape. The body 620 includes the first open end 615 and the second open end 625, the ends having a circular shape. The first open end 615 and the second open end 625 are located on opposite side of the body 620. An axis of symmetry Q is located at the center of circles formed by the ends 615 and 625 as shown in FIG. 6. Pellet 610 includes a channel 630 that is parallel to, or substantially parallel to, the axis of symmetry Q. The channel 630 has a cylindrical shape, or a generally cylindrical shape, and is located in the center of the body 620. The channel 630 spans the entire length of the body 620. Channel 630 extends from the first open end 615 to the second open end 625.

Body 620 has a circular, or a generally circular, cross-sectional shape. Body 620 also has a cylindrical, or a generally cylindrical shape. It is understood that the circular, cross-sectional shape of the body 620 can be altered (i.e., squeezed, pressed or packed), due to forces imparted upon the pellet 610 during industrial scale production and/or handling of the pellet while the pellet is still in a melted state. Consequently, the cross-sectional shape of the body 620 may be more elliptical in shape than circular in shape, thus the definition of “generally circular in cross-sectional shape.”

The body 620 and the channel 630 each has a respective diameter—body diameter 640 and channel diameter 645. The term, “diameter,” as used herein, is the greatest length between two points on body/channel surface that extends through the center, through axis of symmetry Q, of the body/channel. In other words, when the pellet 610 has an elliptical shape (as opposed to a circular shape), the diameter is the major axis of the ellipse. In an embodiment, the shape of the body 620 resembles a hockey puck.

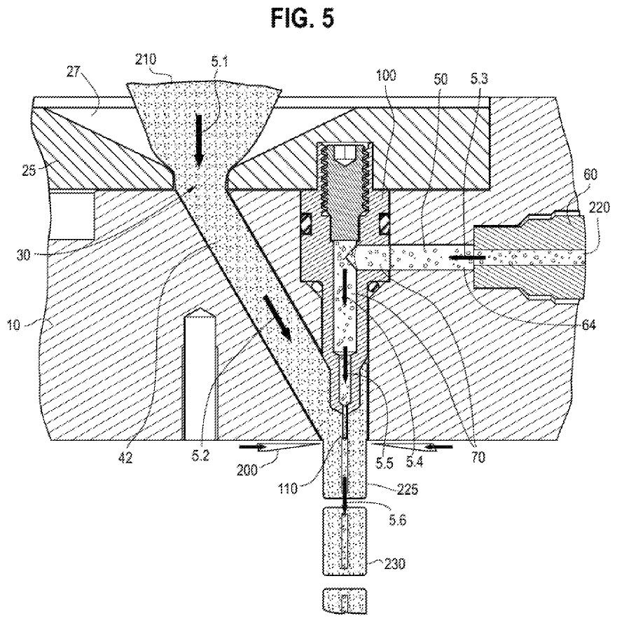

FIG. 7A shows a body diameter 640 and a channel diameter 645 for the pellet 610. In an embodiment, the body diameter 640 is from 0.7 millimeters (mm), or 0.8 mm, or 0.9 mm, or 1.0 mm, or 1.5 mm to 3.7 mm, or 4.0 mm, or 4.2 mm, or 4.6 mm, or 5.0 mm. In a further embodiment, the body diameter 640 is from 0.7 to 5.0 mm, or from 0.8 to 4.2 mm, or from 1.0 to 4.0 mm. In an embodiment, the channel diameter 645 is from 0.10 mm, or 0.13 mm, or 0.15 mm, or 0.18 mm to 0.3 mm, or 0.4 mm, or 0.5 mm, or 0.6 mm, or 0.8 mm or 1 mm, or 1.6 mm, or 1.8 mm. In a further embodiment, the channel diameter 645 is from 0.10 to 1.8 mm, or from 0.15 to 1.6 mm, or from 0.18 to 1 mm, or from 0.18 to 0.8 mm, or from 0.18 to 0.6 mm.

The pellet has a channel diameter-to-body diameter (CBD) ratio. The term, “channel diameter-to-body diameter (or “CBD”) ratio”, as used herein, refers to the result obtained by dividing the channel diameter by the body diameter (i.e., the CBD is the quotient of the channel diameter and the body diameter). For example when the channel diameter is 2.0 mm and the body diameter is 7.0 mm, the CBD ratio is 0.29. In an embodiment, the CBD ratio is from 0.03, or 0.05, or 0.07, or 0.11 to 0.13, or 0.15, or 0.2, or 0.25, or 0.3, or 0.35, or 0.4, or 0.45, or 0.5. In a further embodiment, the CBD ratio is from 0.03 to 0.5, or from 0.05 to 0.45, or from 0.05 to 0.25, or from 0.05 to 0.15, or from 0.11 to 0.15.

FIG. 7B shows a length 635 for the body 620. In an embodiment, the length 635 is from 0.4 mm, or 0.8 mm, or 1 mm, or 1.2 mm, or 1.4 mm, or 1.5 mm, or 1.6 mm, or 1.7 mm to 1.9 mm, or 2 mm, or 2.2 mm, or 2.5 mm, or 3 mm, or 3.3 mm, or 3.5 mm, or 4 mm. In a further embodiment, the length 635 is from 0.4 to 4 mm, or from 0.8 to 3.5 mm, or from 1 to 3.5 mm, or from 1.4 to 2.5 mm, or from 1.5 to 1.9 mm.

In an embodiment: (i) the length 635 is from 0.4 mm, or 0.8 mm, or 1 mm, or 1.2 mm, or 1.4 mm, or 1.5 mm, or 1.6 mm, or 1.7 mm to 1.9 mm, or 2 mm, or 2.2 mm, or 2.5 mm, or 3 mm, or 3.3 mm, or 3.5 mm, or 4 mm; (ii) the body diameter 640 is from 0.7 millimeters (mm), or 0.8 mm, or 0.9 mm, or 1.0 mm, or 1.5 mm to 3.7 mm, or 4.0 mm, or 4.2 mm, or 4.6 mm, or 5.0 mm; and (iii) the channel diameter 645 is from 0.10 mm, or 0.13 mm, or 0.15 mm, or 0.18 mm to 0.3 mm, or 0.4 mm, or 0.5 mm, or 0.6 mm, or 0.8 mm or 1 mm, or 1.6 mm, or 1.8 mm. In a further embodiment: (i) the length 635 is from 0.4 to 4 mm, or from 0.8 to 3.5 mm, or from 1 to 3.5 mm, or from 1.4 to 2.5 mm, or from 1.5 to 1.9 mm; (ii) the body diameter 640 is from 0.7 to 5.0 mm, or from 0.8 to 4.2 mm, or from 1.0 to 4.0 mm; and (iii) the channel diameter 645 is from 0.10 to 1.8 mm, or from 0.15 to 1.6 mm, or from 0.18 to 1 mm, or from 0.18 to 0.8 mm, or from 0.18 to 0.6 mm.

Returning to FIG. 6, a first face 655 of pellet 610 is shown. The first face 655 is located at the first open end 615. A first orifice 650 is located in the center of the first face 655. The first orifice 650 is circular in shape, or generally circular in shape, and opens into the channel 630. The first orifice 650 has an area that is a function of the channel diameter 645. It is understood that the area of the first orifice 650 is a void space and the first orifice 650 does not have a surface. The first face 655 and the first orifice 650 form concentric circles that are bisected by the axis of symmetry Q. The first face 655 has a surface that does not include the first orifice 650. In other words, the first face 655 has the shape of a flat ring.

A second orifice 660 is located in the center of a second face 665. The second orifice 660 is circular in shape, or generally circular in shape, and opens into the channel 630. The second orifice 660 has an area that is a function of the channel diameter 645. It is understood that the area of the second orifice 660 is a void space and the first orifice 660 does not have a surface. The second face 665 and the second orifice 660 form concentric circles that are bisected by the axis of symmetry Q. The second face 665 has a surface that does not include the second orifice 660. In other words, the second face 665 has the shape of a flat ring.

The first face 655 has a “first surface area” that is the product of the expression (0.25×π×[(the body diameter 640)²−(the channel diameter 645)²]). The second face 665 has a “second surface area” that is the product of the expression (0.25×π×[(the body diameter 640)²−(the channel diameter 645)²]). The surface area of the first face 655 is equal to the surface area of the second face 665.

The body 620 has a body surface that includes a “facial surface.” The facial surface includes the first face 655 and the second face 665. The facial surface has a “facial surface area” that is the sum of the surface area of the first face 655 and the surface area of the second face 665. The facial surface area is the product of the expression 2×(0.25×π×[(the body diameter 640)²−(the channel diameter 645)²]).

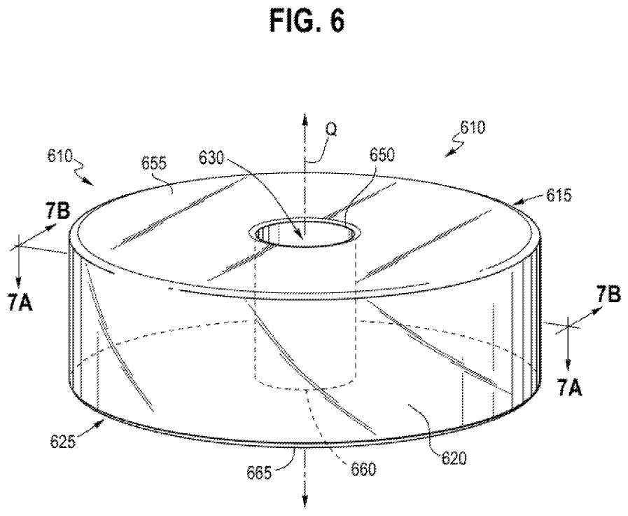

FIG. 8 shows a shell 670. The shell 670 is the outer surface of the body 620 that is parallel to the axis of symmetry Q. Shell 670 has a cylindrical, or a generally cylindrical shape. Shell 670 includes a “shell surface” and a “shell surface area,” the latter of which is the product of the expression (π×the body diameter 640×the length 635). The body 620 has a “body surface” that includes the shell surface and the facial surface. The body surface has a “body surface area” that is the sum of the shell surface area and the facial surface area. In an embodiment, the body surface area is from 25 square millimeters (mm²), or 30 mm², or 32 mm², or 34 mm², or 35 mm² to 40 mm², or 45 mm², or 50 mm². In a further embodiment, the body surface area is from 25 to 50 mm², or from 30 to 45 mm², or from 35 to 40 mm².

The channel 630 has a channel surface 675 including a “channel surface area.” The channel surface area is the product of the expression (π×the channel diameter 645×the length 635). In an embodiment, the channel surface area is from 0.5 mm², or 1 mm², or 2 mm², or 3 mm² to 6 mm², to 7 mm², or 8 mm², or 9 mm², or 10 mm², or 11 mm². In a further embodiment, the channel surface area is from 0.5 to 11 mm², or from 1 to 9 mm², or from 1 to 8 mm², or from 2 to 8 mm².

The pellet 610 has a surface area that is the sum of the body surface area and the channel surface area. In an embodiment, the pellet surface area is from 4 mm², or 15 mm², or 25 mm², or 30 mm², or 35 mm² to 40 mm², or 45 mm², or 50 mm², or 60 mm², or 70 mm², or 80 mm². In a further embodiment, the pellet surface area is from 15 to 80 mm, or from 30 to 60 mm², or from 35 to 50 mm².

In an embodiment, (i) the length 635 is from 0.4 mm, or 0.8 mm, or 1 mm, or 1.2 mm, or 1.4 mm, or 1.5 mm, or 1.6 mm, or 1.7 mm to 1.9 mm, or 2 mm, or 2.2 mm, or 2.5 mm, or 3 mm, or 3.3 mm, or 3.5 mm, or 4 mm; (ii) the body diameter 640 is from 0.7 mm, or 0.8 mm, or 0.9 mm, or 1.0 mm, or 1.5 mm to 3.7 mm, or 4.0 mm, or 4.2 mm, or 4.6 mm, or 5.0 mm; (iii) the pellet surface area is from 4 mm², or 15 mm², or 25 mm², or 30 mm², or 35 mm² to 40 mm², or 45 mm², or 50 mm², or 60 mm², or 70 mm², or 80 mm² and (iv) the CBD ratio is from 0.03, or 0.05, or 0.07, or 0.11 to 0.13, or 0.15, or 0.2, or 0.25, or 0.3, or 0.35, or 0.4, or 0.45, or 0.5. In a further embodiment, (i) the length 635 is from 0.4 to 4 mm, or from 0.8 to 3.5 mm, or from 1 to 3.5 mm, or from 1.4 to 2.5 mm, or from 1.5 to 1.9 mm; (ii) the body diameter 640 is from 0.7 to 5.0 mm, or from 0.8 to 4.2 mm, or from 1.0 to 4.0 mm; (iii) the pellet surface area is from 15 to 80 mm², or from 30 to 60 mm², or from 35 to 50 mm² and (iv) the CBD ratio is from 0.03 to 0.5, or from 0.05 to 0.45, or from 0.05 to 0.25, or from 0.05 to 0.15, or from 0.11 to 0.15.

The pellet 610 has a channel surface area-to-body surface area (CSBS) ratio. The term, “channel surface area-to-body surface area (or “CSBS”) ratio”, as used herein, refers to the result obtained by dividing the channel surface area by the body surface area (i.e., the CSBS is the quotient of the channel surface area by the body surface area). For example when the channel surface area is 2.0 mm² and the body surface area is 7.0 mm², the CSBS ratio is 0.29. In an embodiment, the CSBS ratio is from 0.02, or 0.03, or 0.06, or 0.10, or 0.13 to 0.15, or 0.18, or 0.21, or 0.23, or 0.25, or 0.3. In a further embodiment the CSBS ratio is from 0.02 to 0.3, or from 0.03 to 0.25, or from 0.03 to 0.23, or from 0.03 to 0.21, or from 0.03 to 0.18.

In an embodiment, (i) the length 635 is from 0.4 mm, or 0.8 mm, or 1 mm, or 1.2 mm, or 1.4 mm, or 1.5 mm, or 1.6 mm, or 1.7 mm to 1.9 mm, or 2 mm, or 2.2 mm, or 2.5 mm, or 3 mm, or 3.3 mm, or 3.5 mm, or 4 mm; (ii) the body diameter 640 is from 0.7 mm, or 0.8 mm, or 0.9 mm, or 1.0 mm, or 1.5 mm to 3.7 mm, or 4.0 mm, or 4.2 mm, or 4.6 mm, or 5.0 mm; (iii) the pellet surface area is from 4 mm², or 15 mm², or 25 mm², or 30 mm², or 35 mm² to 40 mm², or 45 mm², or 50 mm², or 60 mm², or 70 mm², or 80 mm² and (iv) the CSBS ratio is from 0.02, or 0.03, or 0.06, or 0.10, or 0.13 to 0.15, or 0.18, or 0.21, or 0.23, or 0.25, or 0.3. In a further embodiment, (i) the length 635 is from 0.4 to 4 mm, or from 0.8 to 3.5 mm, or from 1 to 3.5 mm, or from 1.4 to 2.5 mm, or from 1.5 to 1.9 mm; (ii) the body diameter 640 is from 0.7 to 5.0 mm, or from 0.8 to 4.2 mm, or from 1.0 to 4.0 mm; (iii) the pellet surface area is from 15 to 80 mm², or from 30 to 60 mm², or from 35 to 50 mm² and (iv) the CSBS ratio is from 0.02 to 0.3, or from 0.03 to 0.25, or from 0.03 to 0.23, or from 0.03 to 0.21, or from 0.03 to 0.18.

The pellet 610 (i.e., hollow pellet), may comprise two or more embodiments disclosed herein.

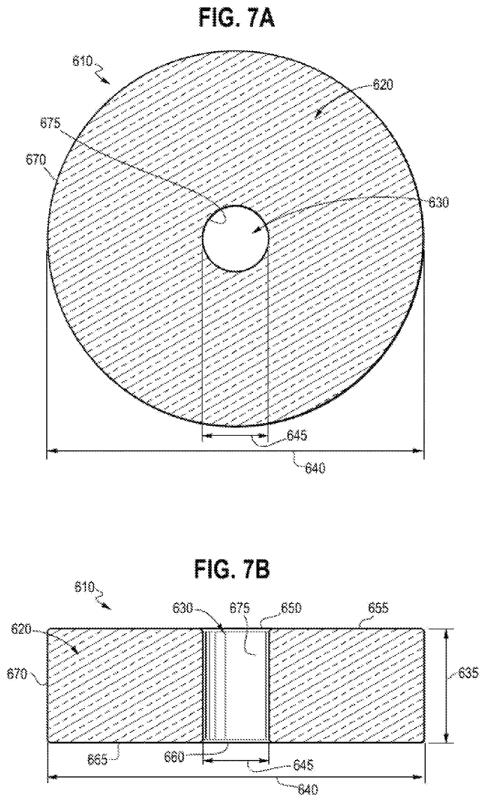

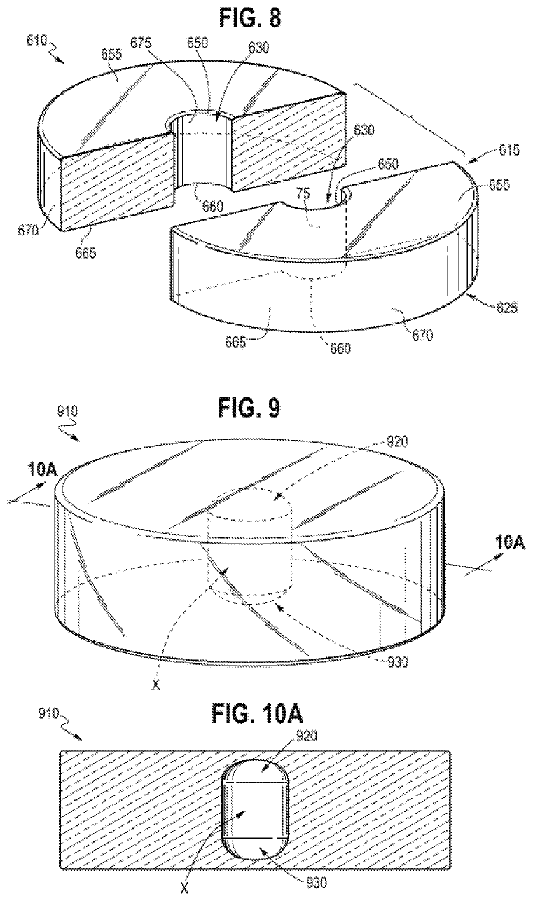

In an embodiment, the setback distance and the extrude viscosity are selected so die assembly 5 produces a fluid-filled pellet 910 having closed ends as shown in FIGS. 9-10A. The pellet 910 includes a first closed end 920, a second closed end 930 and a closed channel X. The remaining features of the pellet 910 are identical to the features of the pellet 610, as described herein. The pellet 910 with first closed end 920 and second closed end 930 is hereafter interchangeably referred to as a “closed pellet.”

The pellet 910 (i.e., closed pellet), may comprise two or more embodiments disclosed herein.

The fluid-filled pellets may comprise two or more embodiments disclosed herein.

### Extrudate

Non-limiting examples of a material suitable for use as the extrudate include an ethylene-based polymer, an olefin-based polymer (i.e., a polyolefin), an organic polymer, a propylene-based polymer, a thermoplastic polymer, a thermoset polymer, a polymer melt-blend, polymer blends thereof and combinations thereof.

Non-limiting examples of suitable ethylene-based polymer include ethylene/alpha-olefin interpolymers and ethylene/alpha-olefin copolymers. In an embodiment, the alpha-olefins include, but are not limited to, C₃-C₂₀ alpha-olefins. In a further embodiment, the alpha-olefins include propylene, 1-butene, 1-pentene, 1-hexene, 1-heptene and 1-octene.

In an embodiment, the extrudate is an aromatic polyester, a phenol-formaldehyde resin, a polyamide, a polyacrylonitrile, a polyethylene terephthalate, a polyimide, a polystyrene, a polytetrafluoroethylene, a polyvinyl chloride, a thermoplastic polyurethane, a silicone polymer and combinations thereof.

The extrudate may comprise two or more embodiments disclosed herein.

### Process

The present disclosure provides a process for making the fluid-filled pellets 230, (e.g., pellet 610). The process includes providing the die assembly 5 including the die plate 10 having the inlet surface 15, the discharge surface 35, the discharge port 45, the extrudate passage 42, and the third axis of symmetry C. The inlet surface includes the inlet 30 and the first axis of symmetry A, as described herein. The discharge surface 35 includes the discharge port 45 and the second axis of symmetry B, as described herein. The die assembly 5 includes the nozzle 100 that has an injection tip 110, as described herein.

The process further includes providing the intake plate 25 having the conically-shaped intake port 27 that is aligned with the inlet 30 shown in FIG. 1A.

The process further includes providing the fluid source 60, the adapter screw 80 and the nozzle 100 wherein the nozzle 100 is mounted in die plate 10 through the combination of the adapter screw 80, the intake plate 25, the second interlocking mechanism, and the third interlocking mechanism shown in FIG. 2.

The process further includes providing: (1) an extruder (not shown) that is operatively connected to the die assembly 5; (2) an extrudate; and (3) passing the extrudate through the inlet 30 into extrudate passage 42, as indicated by arrow 5.1 in FIG. 5, to provide uniform distribution of the extrudate throughout the extrudate passage 42. The process further includes passing the extrudate through the extrudate passage 42 and surrounding the nozzle distal end 108 and the injection tip 110 with the extrudate. The process further includes passing the fluid 50 from the fluid source 60 through the fluid channel 64 and the annular channel 70 as indicated by arrows 5.3, 5.4, 5.5 and 5.6 in FIG. 5. The passing of the extrudate and the passing of the fluid 50 occur simultaneously. The process further comprises injecting, with the injection tip 110, the fluid 50 into the extrudate as it exits the discharge port 45 and forming the fluid-filled extrudate 225. In an embodiment, the process includes injecting, with the injection tip 110 at a setback position O, the fluid 50 into the extrudate as it exits the discharge port 45 and forming the fluid-filled extrudate 225. In an embodiment, the fluid 50 is injected into the extrudate 210 while the fluid is at a pressure from 100,000 Pa to 520,000 Pa (15 psi to 75 psi). The process further comprises cutting, with the rotating blade apparatus 200, the fluid-filled extrudate 225 emerging from the discharge port 45, and forming fluid-filled pellets 230, (e.g., pellet 610).

FIG. 4C. shows an embodiment wherein the process further includes providing the exit plate 300 including the exit face 310, the exit port 320 and the exit channel 330. The process further includes passing the extrudate from the extrudate passage 42 into the exit channel 330 and surrounding the injection tip 110 at the setback position P with the extrudate. The injection tip injects the fluid 50 into the extrudate as the extrudate exits the exit port 320 to form a fluid-filled extrudate 225. The process further includes cutting, with the rotating blade apparatus 200, the fluid-filled extrudate 225 emerging from the exit port 320, and forming fluid-filled pellets 230, (e.g., pellet 610).

In an embodiment, the process includes forming fluid-filled pellets having two open ends, one open end, no open ends (i.e., two closed ends), and combinations thereof.

In an embodiment, the process includes forming hollow pellets 610, as shown in FIG. 6, when the fluid 50 is air and the fluid-filled pellets have two open ends.

In an embodiment, the process comprises forming fluid-filled pellets 910, as shown in FIGS. 9-10, having two closed ends.

The present disclosure is described more fully through the following examples. Unless otherwise noted, all parts and percentages are by weight.

### Examples

The raw materials used in the Inventive Examples (“IE”) are provided in Table 1 below.

TABLE 1

| Trade Name | Chemical Class and Description | Supplier |
|---|---|---|
| XUS 38658.00 | Ethylene/octene copolymer | The Dow |
| | Density: 0.904 g/cm³ | Chemical |
| | MI: 30 g/10 min @ 190° C./2.16 kg | Company |
| XUS 38660.00 | Ethylene/octene copolymer | The Dow |
| | Density: 0.874 g/cm³ | Chemical |
| | MI: 4.8 g/10 min @ 190° C./2.16 kg | Company |
| DXM-447 | Low density polyethylene | The Dow |
| | Density: 0.922 g/cm³ | Chemical |
| | MI: 2.4 g/10 min @ 190° C./2.16 kg | Company |

Comparative Sample 1 (CS-1) and Inventive Examples 1-8 (IE-1 to IE-8) are produced with XUS 38658.00 as the extrudate and the process conditions listed in Table 2. The extrusion process uses a Coperion ZSK-26 twin-screw extruder and a loss-in-weight feeder (K-Tron model KCLQX3). The fluid 50 (e.g., air or N₂) is injected into the extrudate using the die assembly 5 described herein and a Gala underwater rotating blade apparatus forms pellets. The extruder is equipped with 26 millimeter (mm) diameter twin-screws and 11 barrel segments, 10 of which are independently controlled with electric heating and water cooling. The length to diameter ratio of the extruder is 44:1. A light-intensity screw design is used in order to minimize the shear heating of polymer melt.

The injection tip 110 and nozzle 100 are not used in the production of CS-1 because no nitrogen flow is applied. In the absence of nitrogen flow and without the use of the injection tip 110 and nozzle 100 both ends of the pellets are closed.

Fluid-filled pellets (IE-1 to IE-8) are produced using injection tip 100 and nozzle 110 of die assembly 5 to inject nitrogen gas into the extrudate. IE-1 through IE-6 are produced using a nitrogen flow rate of 10 ml/min and a nitrogen pressure between 34 kPag (5 psig) and 410 kPag (60 psig). IE-7 and IE-8 are produced using a nitrogen flow rate of 50 mL/min and a nitrogen pressure of 69 kPag (10 psig).

TABLE 2

| Sample ID | CS-1 | IE-1 | IE-2 | IE-3 | IE-4 | IE-5 | IE-6 | IE-7 | IE-8 |
|---|---|---|---|---|---|---|---|---|---|
| Pellet feed rate (kg/h) | 11.3 | 11.3 | 11.3 | 11.3 | 11.3 | 11.3 | 11.3 | 9.07 | 9.07 |
| N₂ Flow Rate (mL/min) | 0.0 | 10.0 | 10.0 | 10.0 | 10.0 | 10.0 | 10.0 | 50.0 | 50.0 |
| Pressure (kPag) | 0.0 | 34 | 34 | 205 | 205 | 410 | 410 | 69 | 69 |
| Screw RPM | 200 | 200 | 200 | 200 | 200 | 200 | 200 | 150 | 150 |
| Zone #1 (° C.) | 99 | 99 | 99 | 99 | 99 | 99 | 99 | 75 | 75 |
| Zone #2 (° C.) | 164 | 164 | 164 | 164 | 164 | 164 | 164 | 147 | 147 |
| Zone #3 (° C.) | 179 | 179 | 179 | 179 | 179 | 179 | 179 | 160 | 160 |
| Zone #4 (° C.) | 180 | 180 | 180 | 180 | 180 | 180 | 180 | 160 | 160 |
| Zone #5 (° C.) | 179 | 179 | 179 | 179 | 179 | 179 | 179 | 160 | 160 |
| Zone #6 (° C.) | 179 | 179 | 179 | 179 | 179 | 179 | 179 | 160 | 160 |
| Zone #7 (° C.) | 179 | 179 | 179 | 179 | 179 | 179 | 179 | 160 | 160 |
| Zone #8 (° C.) | 179 | 179 | 179 | 179 | 179 | 179 | 179 | 160 | 160 |
| Zone #9 (° C.) | 179 | 179 | 179 | 179 | 179 | 179 | 179 | 160 | 160 |
| Zone #10 (° C.) | 180 | 180 | 180 | 180 | 180 | 180 | 180 | 167 | 167 |
| Torque (%) | 40 | 40 | 40 | 40 | 40 | 40 | 40 | 49 | 49 |
| Die pressure (kPag) | 4902 | 4902 | 4902 | 4902 | 4902 | 4902 | 4902 | 6900 | 6900 |
| Diverter Valve (° C.) | 180 | 180 | 180 | 180 | 180 | 180 | 180 | 160 | 160 |
| Die Temp (° C.) | 220 | 220 | 220 | 220 | 220 | 220 | 220 | 150 | 150 |
| Water Temp (° C.) | 16 | 16 | 16 | 16 | 16 | 16 | 16 | 4.4 | 4.4 |
| Pellet End Type | Closed | Open | Open | Open | Open | Open | Open | Open | Open |

The dimensions of the pellets formed from process conditions IE-1 to IE-8 from Table 2 are imaged with optical microscopy. The results of the optical microscopy of pellets IE-1 to IE-8 are listed in Table 3.

TABLE 3

| | Channel | Body | Pellet | Body | Channel | Pellet | | |
|---|---|---|---|---|---|---|---|---|
| Sample | Diameter | Diameter | Length | S.A. | S.A. | S.A. | CBD | CSBS |
| ID | (mm) | (mm) | (mm) | (mm²) | (mm²) | (mm²) | Ratio | Ratio |
| IE-1 | 0.18 | 3.33 | 1.8 | 36.2 | 1.02 | 37.2 | 0.054 | 0.03 |
| IE-2 | 0.37 | 3.22 | 1.8 | 34.3 | 2.09 | 36.4 | 0.11 | 0.06 |
| IE-3 | 0.82 | 3.34 | 1.8 | 35.3 | 4.63 | 40.0 | 0.25 | 0.13 |
| IE-4 | 0.39 | 3.51 | 1.8 | 38.9 | 2.20 | 41.2 | 0.11 | 0.06 |
| IE-5 | 0.63 | 3.35 | 1.8 | 35.9 | 3.56 | 39.5 | 0.19 | 0.10 |
| IE-6 | 0.55 | 3.57 | 1.8 | 39.7 | 3.11 | 42.8 | 0.15 | 0.08 |
| IE-7 | 0.99 | 3.56 | 1.8 | 38.5 | 5.60 | 44.0 | 0.28 | 0.15 |
| IE-8 | 1.52 | 3.79 | 1.8 | 40.4 | 8.59 | 48.9 | 0.40 | 0.21 |

CBD is ratio of channel diameter to body diameter
CSBS is ratio of channel surface area to body surface area
S.A. is surface area

Inventive Examples 9 and 10 (IE-9 and IE-10) listed in Table 4 are produced using the experimental conditions summarized in Table 2, except for where noted otherwise. The extrusion temperature is 200° C. The pellet channel diameter of IE-9 is approximately 0.90 mm. The pellet formed in IE-10 has an oval shape with a short axis of 0.64 mm and a long axis of 1.27 mm.

TABLE 4

| Sample ID | IE-9 | IE-10 |
|---|---|---|
| Polymer Resin | XUS38660.00 | DXM-447 |
| Pellet feed rate (kg/h) | 9.07 | 9.07 |
| N₂ Flow Rate (ml/min) | 50.0 | 50.0 |
| N₂ Pressure (kPag) | 69 | 69 |
| Screw RPM | 200 | 200 |
| Zone #1 (° C.) | 99 | 100 |
| Zone #2 (° C.) | 159 | 159 |
| Zone #3 (° C.) | 200 | 200 |
| Zone #4 (° C.) | 199 | 200 |
| Zone #5 (° C.) | 199 | 200 |
| Zone #6 (° C.) | 199 | 200 |
| Zone #7 (° C.) | 199 | 200 |
| Zone #8 (° C.) | 199 | 200 |
| Zone #9 (° C.) | 200 | 200 |
| Zone #10 (° C.) | 202 | 200 |
| Torque (%) | 48 | 45 |
| Die pressure (kPag) | 7577 | 7729 |
| Diverter Valve (° C.) | 200 | 200 |
| Die temp (° C.) | 210 | 210 |
| RPM | 1400 | 1200 |
| Water temp (° C.) | 8 | 8 |

It is specifically intended that the present disclosure not be limited to the embodiments and illustrations contained herein, but include modified forms of those embodiments including portions of the embodiments and combinations of elements of different embodiments as come with the scope of the following claims.

1. A die assembly comprising:
(i) a die plate having an inlet surface and an opposing discharge surface;
(ii) an inlet on the inlet surface and a first axis of symmetry extending through the inlet and perpendicular to the inlet surface;
(iii) a discharge port on the discharge surface and a second axis of symmetry extending through the discharge port and perpendicular to the discharge surface, the second axis of symmetry spaced apart from, and parallel to, the first axis of symmetry;
(iv) an extrudate passage fluidly connecting the inlet and the discharge port, and a third axis of symmetry extending through the extrudate passage;
(v) a nozzle mounted in the die plate, the nozzle having an injection tip in the extrudate passage at the discharge port; and
(vi) the third axis of symmetry intersects the first axis of symmetry at the inlet to form an acute angle.

2. The die assembly of claim 1 wherein the third axis of symmetry intersects the second axis of symmetry at the discharge port to form an acute angle.

3. The die assembly of claim 1 wherein the nozzle is a step nozzle.

4. The die assembly of claim 3 wherein the nozzle has
a distal end that includes the injection tip; and
a proximate end opposite the injection tip, the nozzle proximate end in fluid communication with a fluid source.

5. The die assembly of claim 4 wherein the nozzle distal end has an tip inner diameter (TID) and the nozzle proximate end has an proximate inner diameter (PID) wherein the PID is greater than the TID.

6. The die assembly of claim 1 wherein the injection tip is located at a setback position that is from 0.05 mm to 0.15 mm upstream of the discharge face.

7. The die assembly of claim 6 wherein the extrudate passage surrounds the injection tip at the setback position.

8. The die assembly of claim 7 wherein the TID is from 0.25 mm to 0.35 mm.

9. The die assembly of claim 8 wherein the injection tip has an outer diameter from 0.60 mm to 0.90 mm.

10. The die assembly of claim 1, further comprising an intake plate attached to an upstream face of the die plate, the intake plate having a conical-shaped intake port, the intake port adjacent to the inlet.

11. The die assembly of claim 1 comprising a rotating blade apparatus in operative communication with the discharge port of the discharge face.

12. The die assembly of claim 11, comprising:
an extrudate in the extrudate passage, the extrudate surrounding the nozzle injection tip;
the nozzle injection tip injecting a fluid into the extrudate as the extrudate exits the discharge port to form a fluid-filled extrudate; and
the rotating blade apparatus cutting the fluid-filled extrudate to form fluid-filled pellets.

13. The die assembly of claim 12 wherein the fluid-filled pellets have open ends.

14. The die assembly of claim 12 wherein the fluid-filled pellets have closed ends.

15. The die assembly of claim 1 comprising
an exit plate attached to the discharge face of the die plate, the exit plate having an exit face and an exit port located on the exit face;
a channel in the exit plate, the channel fluidly connecting the discharge port to the exit port; and
the nozzle injection tip extending into the channel, the channel surrounding the injection tip.
